(19) United States
(12) Patent Application Publication
(10) Pub. No.: US 2023/0190034 A1
(43) Pub. Date: Jun. 22, 2023

(54) COOKING UTENSIL AND METHOD FOR MANUFACTURING THEREOF

(71) Applicant: KE M.O. HOUSE CO., LTD, Shengzhen (CN)

(72) Inventors: Mou-Fu TSAI, Shengzhen (CN); Pin LYU, Shengzhen (CN)

(21) Appl. No.: 17/865,507

(22) Filed: Jul. 15, 2022

(30) Foreign Application Priority Data
Dec. 20, 2021 (CN) 202111563856.5

(51) Int. Cl. A47J 36/02; A47J 36/04; A47J 37/10; B05D 1/02; B05D 3/12; B05D 3/02; B05D 3/10; B05D 7/00

(52) U.S. Cl. CPC A47J 36/025; A47J 36/04; A47J 37/10; B05D 1/02; B05D 3/12; B05D 3/0254; B05D 3/0209; B05D 3/102; B05D 7/587

(57) ABSTRACT

The present disclosure provides a cooking utensil, comprising a blank of the cooking utensil, and a non-stick layer coated on the surface of the blank; the non-stick layer comprises a primer layer in contact with one side of the blank, and a sheet-like graphene, a sheet-like graphene derivative or a combination thereof uniformly distributed in the primer layer. The present disclosure also provides a method for manufacturing of the cooking utensil. The present disclosure fully realizes the heat conduction between the blank and the food through the sheet-like graphene, the sheet-like graphene derivative or the combination thereof, and effectively improves the heating speed and the heating uniformity.

### CROSS-REFERENCE TO RELATED APPLICATIONS

This application claims the benefit of China Patent Application Serial No. 202111563856.5, filed on Dec. 20, 2021, the subject matter of which is incorporated herein by reference.

### TECHNICAL FIELD

The present disclosure relates to the technical field of cooking utensils, in particular to a cooking utensil and a preparation method.

### BACKGROUND OF RELATED ARTS

In the traditional cookware and household appliance industry, in order to make the product non-stick, the surface of the product is usually sprayed with a low surface tension or low coefficient of friction coating. For example, a non-stick coating can be sprayed to form a non-stick layer. Existing non-stick coatings are mainly divided into two categories, one of which is fluorocarbon coatings and the other is silicon coatings. Fluorocarbon coatings are represented by polytetrafluoroethylene (PTFE). PTFE is a linear polymer with high molecular weight and large volume, which leads to the problem of low density of the non-stick layer, PTFE is a linear polymer with the characteristics of high molecular weight and large volume, which leads to the problem of low density of the non-stick layer, and due to its low heat resistance (only 250° C. long-term use temperature), there is a certain degree of deficiency about the protection of metal substrates. In addition, the thermal conductivity of PTFE is only 0.25 W/mK, so the heating efficiency of the product is poor. In addition, although the hardness of silicon coating can reach 8H or above, it has the problem of poor wear resistance. When the silicon coating on the surface of the product is worn, the non-stickiness will drop significantly, which cannot meet the customer's expectations.

Both fluorocarbon coatings and silicon coatings have low thermal conductivity, so they have the disadvantage of low heating efficiency when used in cookware products.

### SUMMARY

The purpose of the present disclosure is to provide a cooking utensil, the present disclosure fully realizes the heat conduction between the blank and the food through a sheet-like graphene, a sheet-like graphene derivative or a combination thereof, and effectively improves the heating speed and the uniformity of heating.

In order to solve this technical problem, the technical scheme of the present disclosure is: a cooking utensil, including a blank of the cooking utensil, and a non-stick layer coated on a surface of the blank; wherein the non-stick layer includes a primer layer in contact with one side of the blank, and a sheet-like graphene, a sheet-like graphene derivative or a combination thereof uniformly distributed in the primer layer.

In a preferred embodiment, the mass fraction of the sheet-like graphene, the sheet-like graphene derivative or the combination thereof in a water-based paint for forming the primer layer is 28% to 32%. In the present disclosure, by controlling the amount of the sheet-like graphene, the sheet-like graphene derivative or the combination thereof in the primer layer, sufficient contact between the primer layer and the blank is fully ensured. The primer layer and the blank are fully combined and have reliable connection, thereby improving wear resistance of the non-stick layer. At the same time, the excellent thermal conductivity of the sheet-like graphene, the sheet-like graphene derivative or the combination thereof is used to shorten the heating time and improve the uniformity of heating.

In a preferred embodiment, a side of the blank facing the non-stick layer has a uniformly rough structure and have a roughness of 3 μm to 5 μm. In the present disclosure, the roughness of the surface of the blank ensures that the primer layer, especially the sheet-like graphene, the sheet-like graphene derivative or the combination thereof, has more contact area with the blank than a planar surface, and the two are combined more firmly with each other. At the same time, the sheet-like graphene, the sheet-like graphene derivative or the combination thereof are evenly spread in the primer layer to form a certain orderly arrangement, which fully improves the heat transfer effect.

In a preferred embodiment, the radial width of the sheet-like graphene, the sheet-like graphene derivative, or the combination thereof is 5 μm to 20 μm. The sheet-like graphene, the sheet-like graphene derivative, or the combination thereof with a radial width of 5 μm to 20 μm is selected to cooperate with the primer layer and the sealing layer, the sheet-like graphene, the sheet-like graphene derivative, or the combination thereof in the primer layer are limited by the blank with the rough surface and the sealing layer to form an orderly tile, giving full play to the thermal conductivity of the sheet-like graphene, the sheet-like graphene derivative, or the combination thereof to ensure the heat transfer rate and the uniformity of thermal conductivity.

In a preferred embodiment, a thickness of the non-stick layer is ranging from 50 μm to 60 μm. The non-stick layer of the present disclosure sufficiently guarantees the wear resistance.

The object of the present disclosure is to provide a method for manufacturing of a cooking utensil. The present disclosure combines a sheet-like graphene, a sheet-like graphene derivative or a combination thereof with a rough structure of a blank of the cooking utensil, in order to effectively improve thermal conductivity and wear resistance of the obtained cooking utensils with a target non-stick layer.

In order to solve this technical problem, the technical scheme of the present disclosure is: a method for manufacturing of a cooking utensil, including steps of:

S10: roughening a surface of a blank of a cooking utensil, then proceeding to step S20;

S20: spraying a water-based paint containing a sheet-like graphene, a sheet-like graphene derivative or a combination thereof that forms a primer layer on the surface of the blank, then spraying a sealing layer on the undried surface of the primer layer, and baking, and then proceeding to step S30; and

S30: spraying a medium oil layer and a surface oil layer on a surface of the sealing layer in sequence, and then performing firing to obtain a cooking utensil with a non-stick layer.

In a preferred embodiment, the step S10 further includes a cleaning step and a drying step that after finishing the step of roughening the surface of the blank of the cooking utensil, firstly performing alkaline cleaning at 35° C. to 45° C., then carry out two rounds of washing with water at room temperature, then carrying out acid cleaning at room temperature, then carrying out washing with water at room temperature, and then carrying out washing with pure water at room temperature, and finally drying at 150° C. In the present disclosure, the oil and oxides on the surface of the roughened blank are effectively removed by washing with alkali, water, acid and water, so as to facilitate and assist the spraying of the primer layer in the next step.

The “baking” described in the step S20 is baking at a temperature ranging from 150° C. to 180° C. for 3 minutes to 5 minutes.

The “firing” described in the step S30 is firing at a temperature of 430° C. for 3 minutes to 5 minutes.

In a preferred embodiment, the step S10 is roughening the surface of the blank of the cooking utensil by sandblasting, and the surface roughness of the blank is 3 μm to 5 μm.

The sealing layer is formed by 10% polyethersulfone resin and 5% polyamide-imide resin, which are closely combined with polytetrafluoroethylene resin at 150° C. to 180° C., and the mass fraction is 20% to 22%.

The medium oil layer is formed by filling a material containing 3% to 5% of silicon carbide uniformly into 30% to 55% of fluoropolymer resin at a temperature of 430° C.

The surface oil layer is using 30% to 55% of fluoropolymer resin co-formed with 10% polytetrafluoroethylene derived copolymer at a temperature of 430° C., and the mass fraction is 20%.

By adopting the above-mentioned technical scheme, the advantageous effects of the present disclosure are:

The disclosure provides a cooking utensil with a non-stick layer. First, a primer layer is attached to a surface of a blank of the cooking utensil, and the primer layer is orderly spread with a sheet-like graphene, a sheet-like graphene derivative or a combination thereof. The orderly arrangement of the sheet-like graphene, the sheet-like graphene derivative or the combination thereof effectively ensure the great performance of the thermal conductivity of the sheet-like graphene, the sheet-like graphene derivative or the combination thereof. Not only the heat conduction is uniform and fast, but also the sheet-like graphene, the sheet-like graphene derivative or the combination thereof in the primer layer have excellent mechanical properties. When the sheet-like graphene derivative, the sheet-like graphene derivative or the combination thereof in the primer layer in cooperation with the uniformly rough structure of the blank, an effective support for the entire non-stick layer is performed. The sealing layer forms an effective protection for o the sheet-like graphene, the sheet-like graphene derivative or the combination thereof. Compared with the traditional fluorocarbon coating, the non-stick layer of the present disclosure has the advantages of high surface hardness, good corrosion resistance, long-lasting wear resistance, good non-stickiness and long service life, and is a wear-resistant non-stick layer with environmentally-friendliness, efficiency and comprehensive performance.

The disclosure effectively guarantees the firmness and wear resistance of the product, thereby achieving the above-mentioned purpose of the present disclosure.

### BRIEF DESCRIPTION OF DRAWINGS

FIG. 1 is a cross-sectional view of a cooking utensil according to the present disclosure.

FIG. 2 is an enlarged view of part A in FIG. 1.

FIG. 3 is a step diagram of a method for manufacturing of a cooking utensil according to the present disclosure.

### DETAILED DESCRIPTIONS OF EMBODIMENTS

In order to further explain the technical content of the present disclosure, the present disclosure will be described in detail below through specific embodiments.

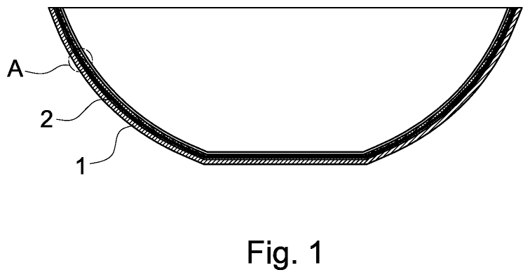

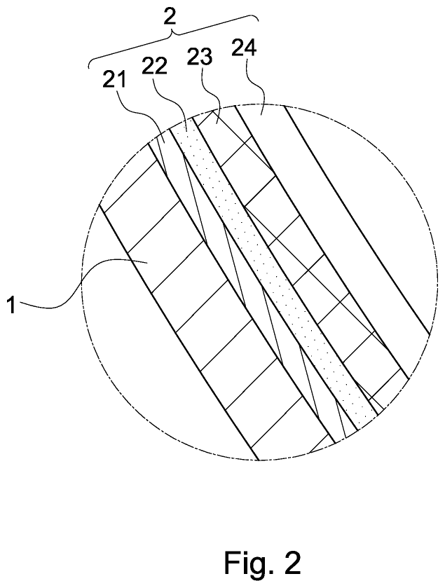

As shown in FIG. 1, the present disclosure provides a cooking utensil, including a blank 1 of the cooking utensil, and a non-stick layer 2 coated on the surface of the blank 1; wherein the non-stick layer 2 comprises a primer layer 21 in contact with one side of the blank 1, and a sheet-like graphene, a sheet-like graphene derivative or a combination thereof uniformly distributed in the primer layer 21; wherein the mass fraction of the sheet-like graphene, the sheet-like graphene derivative or the combination thereof in a water-based paint used to form the primer layer 21 is 28% to 32%; wherein a side of the blank 1 facing the non-stick layer 2 has a uniformly rough structure having a roughness ranging from 3 μm to 5 μm; wherein a radial width of the sheet-like graphene, the sheet-like graphene derivative or the combination thereof is ranging from 5 μm to 20 μm; wherein a thickness of the non-stick layer 2 is ranging from 50 μm to 60 μm. Further as shown in FIG. 2, the non-stick layer 2 includes a sealing layer 22, a middle oil layer 23 and a surface oil layer 24 in order on the top of the primer layer 21. Among the thickness percentages of each layer, the thickness of the primer layer 21 is 35% to 45%, and the thickness of the sealing layer 22 is 15% to 25%, wherein the thickness of the middle oil layer 23 is 20%, and the thickness of the surface oil layer 24 is 20%.

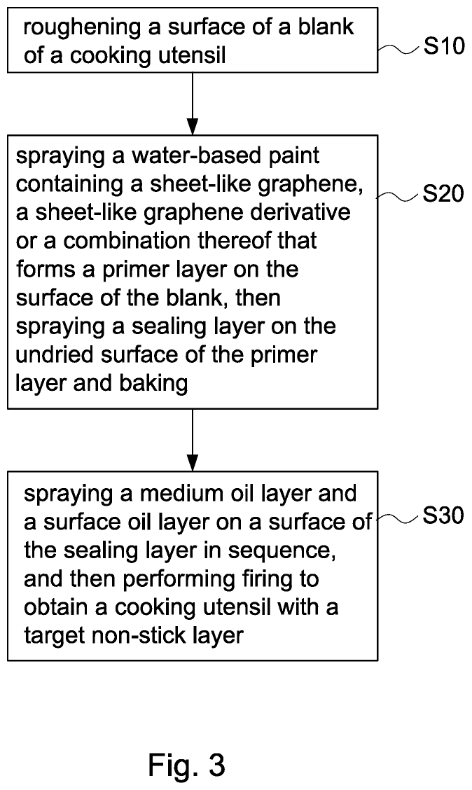

The present disclosure also provides method for manufacturing of a cooking utensil, as shown in FIG. 3, including the following steps:

S10: roughening a surface of a blank 1 of a cooking utensil, then proceeding to step S20; wherein “roughening the surface of the blank 1” described in the step S10 is roughening the surface of the blank 1 of the cooking utensil by sandblasting, and the surface roughness of the blank 1 is 3 μm to 5 μm; wherein the step S10 further includes a cleaning step and a drying step that after finishing the step of roughening the surface of the blank of the cooking utensil, firstly performing alkaline cleaning at 35° C. to 45° C., then carry out two rounds of washing with water at room temperature, then carrying out acid cleaning at room temperature, then carrying out washing with water at room temperature, and then carrying out washing with pure water at room temperature, and finally drying at 150° C.

S20: spraying a water-based paint containing a sheet-like graphene, a sheet-like graphene derivative or a combination thereof that forms a primer layer 21 on the surface of the blank 1, then spraying a sealing layer 22 on the undried surface of the primer layer 21, and baking, and then proceeding to step S30; wherein the mass fraction of the sheet-like graphene, the sheet-like graphene derivative or the combination thereof in a water-based paint used to form the primer layer 21 is 28% to 32%; wherein the sealing layer 22 is formed by 10% polyethersulfone resin and 5% polyamide-imide resin, which are closely combined with polytetrafluoroethylene resin at 150° C. to 180° C., and the mass fraction is 20% to 22%; wherein the baking described in the step S20 is baking at a temperature ranging from 150° C. to 180° C. for 3 minutes to 5 minutes. If the mass fraction of the sheet-like graphene, the sheet-like graphene derivative or the combination thereof in the water-based paint is lower than 28% or higher than 32%, the thermal conductivity uniformity and thermal conductivity rate will be significantly reduced. In addition, if the primer layer 21 is dried before spraying the sealing layer 22 on the surface, the hardness, wear durability and salt water corrosion resistance will be reduced.

S30: spraying a medium oil layer 23 and a surface oil layer 24 on a surface of the sealing layer 22 in sequence, and then performing firing to obtain a cooking utensil with a non-stick layer 2; wherein the firing described in the step S30 is firing at a temperature of 430° C. for 3 minutes to 5 minutes; wherein the medium oil layer is formed by filling a material containing 3% to 5% of silicon carbide uniformly into 30% to 55% of fluoropolymer resin at a temperature of 430° C., to improve non-stickiness and wear resistance; wherein the surface oil layer is using 30% to 55% of fluoropolymer resin co-formed with a polytetrafluoroethylene derived copolymer at a temperature of 430° C., and the mass fraction is 20%, to further strengthen the non-stickiness.

According to the description above, by controlling the amount of the sheet-like graphene, the sheet-like graphene derivative or the combination thereof in the primer layer 21, sufficient contact between the primer layer 21 and the blank 1 is fully ensured. The primer layer 21 and the blank 1 are fully combined and have reliable connection, thereby improving wear resistance of the non-stick layer 2. At the same time, the excellent thermal conductivity of the sheet-like graphene, the sheet-like graphene derivative or the combination thereof is used to shorten the heating time and improve the uniformity of heating. The roughness of the surface of the blank 1 ensures that the primer layer 21, especially the sheet-like graphene, the sheet-like graphene derivative or the combination thereof, has more contact area with the blank 1 than a planar surface, and the two are combined more firmly with each other. At the same time, the sheet-like graphene, the sheet-like graphene derivative or the combination thereof are evenly spread in the primer layer 21 to form a certain orderly arrangement, which fully improves the heat transfer effect. The sheet-like graphene, the sheet-like graphene derivative, or the combination thereof with a radial width of 5 μm to 20 μm is selected to cooperate with the primer layer 21 and the sealing layer 22, the sheet-like graphene, the sheet-like graphene derivative, or the combination thereof in the primer layer 21 are limited by the blank with the rough surface and the sealing layer 22 to form an orderly tile, giving full play to the thermal conductivity of the sheet-like graphene, the sheet-like graphene derivative, or the combination thereof to ensure the heat transfer rate and the uniformity of thermal conductivity. The thickness of the non-stick layer 2 is ranging from 50 μm to 60 μm. The non-stick layer 2 of the present disclosure sufficiently guarantees the wear resistance. The sheet-like graphene, the sheet-like graphene derivative or the combination thereof cooperates with the rough structure of the blank 1 of the cooking utensil to effectively improve the thermal conductivity and wear resistance of the obtained cooking utensil with the target non-stick layer 2.

Example 1, Example 2, Example 3, and Example 4 are presented below. The difference between Examples 1 to 4 is that the thickness ratio of each layer in the non-stick layer 2 is different, as shown in Table 1. The cooking utensils used are all pans of the same style. Examples 1 to 4 are all cooking utensils with the target non-stick layer 2 obtained according to the method for manufacturing the aforementioned cooking utensil. The primer layers 21 are all prepared with a water-based paint containing sheet-like graphene, and the mass fraction of sheet-like graphene in the water-based paint is 28% to 32%.

TABLE 1
The thickness ratio of each layer in the non-stick layers
obtained in Examples 1 to 4

| item | Example 1 | Example 2 | Example 3 | Example 4 |
|---|---|---|---|---|
| primer layer | 35% | 38% | 40% | 45% |
| sealing | 25% | 22% | 20% | 15% |
| layer | | | | |
| medium oil | 20% | 20% | 20% | 20% |
| layer | | | | |
| surface oil | 20% | 20% | 20% | 20% |
| layer | | | | |

The performance test of Examples 1 to 4 and the reference example is carried out, and the specific test method is shown in the following T1-T6, and the specific performance test data is shown in Table 2; wherein the comparative example is using the pan with the same style, and the non-stick coating used is the conventional PTFE coating.

T1: wear resistance (2.5 kg dry grinding):

The sample is fixed on the abrasion tester, then 3M7447B scouring pad (length 70 mm, width 30 mm) is put into the sample, the scouring pad is pressed down with a force of 2.5 kg, and the surface of the sample is wiped back and forth across at a rate of 33 times/min. The scouring pad is changed every 500 times, and the number of wipes back and forth are recorded until the metal substrate is exposed. The higher the number of wipes recorded, the higher the abrasion durability.

T2: non-stickiness test (frying an egg without oil) The sample is placed on a flat-panel electric furnace for dry heating. When the surface temperature of the inner coating reaches 140° C. to 170° C., a fresh egg is broken and added into the sample. When the egg whites are basically solidified (the temperature of the inner surface of the sample should not exceed 210° C.), the eggs are poured out directly without external force. The preceding steps are repeated continuously, and the number of eggs tested are recorded until the sample sticks. The more eggs tested, the better the non-stickiness.

T3: Coating hardness test

The STAEDTLER pencils are used on 46 grit corundum sandpaper to smooth the tip of the lead to make the edge of the lead sharp. The pencil is placed correctly on the pencil hardness tester and the pencil hardness tester is pushed forward with horizontal force. After a scratch about 10 mm to 20 mm long is drawn on the coated surface of the sample, check whether the coated surface is scratched. If it is scratched, replace it with a pencil with lower hardness in turn and continue the test according to the above steps; if it is not scratched, record the hardness of the pencil in this test. The hardness of the pencil decreases from 9H to 8H, 7H, 6H, 5H, 4H, 3H, 2H, H in turn.

T4: thermal conductivity uniformity

A flat-panel electric furnace is used to heat the sample, and the thermal conductivity is observed with an infrared thermal imager. The more types of color images, the greater the temperature difference. The more irregular the color image pattern, the more uneven the temperature.

T5: heat conduction speed test

The sample is put on the induction cooker for dry heating. The time to ramp to 50° C. to 55° C. is recorded, and the time to ramp to 150° C. to 155° C. is recorded. The temperature increase time from 50° C. to 150° C. is calculated. The shorter the heating time, the faster the heat conduction.

T6: corrosion resistance test

10 wt % salt water with more than half of the height of the pot wall to the sample. The salt water is firstly boiled on high heat, and then kept boiled on low heat. During this period, pure water is kept adding to keep the salt water concentration unchanged, until the 24th hour clean water is used to wash the sample. Observe whether the surface of the sample is corroded. If the surface of the sample is not corroded, repeat the above steps until the sample is corroded, and record the time it takes for the sample to corrode. The longer it takes, the better the corrosion resistance. The “salt water” mentioned therein is an aqueous sodium chloride solution.

TABLE 2
Performance index of the same style of frying pans obtained in
Examples 1 to 4 and Comparative Example

| | | | | | | Corrosion |
|---|---|---|---|---|---|---|
| | | | | | | resistance |
| | Wear | non- | Coating | Thermal | Thermal | (10 wt % |
| item | durability | stickiness | hardness | uniformity | conductivity | salt water) |
| Example 1 | 80,000 | 870 or so | 5H | white-yellow- | 90 seconds | 72 hours |
| | times | | | orange-purple-blue | | |
| Example 2 | 100,000 | More than | 6H | white-yellow- | 70 seconds | 240 hours |
| | times | 1000 | | orange-blue | | |
| Example 3 | 110,000 | More than | 7H | white-yellow- | 70 seconds | 240 hours |
| | times | 1000 | | orange-blue | | |
| Example 4 | 100,000 | More than | 5H | white-yellow- | 120 seconds | 96 hours |
| | times | 1000 | | orange-purple-blue | | |
| Comparative | 10,000 | 127 or so | 2H | white-yellow- | 150 seconds | 24 hours |
| example | times | | | light yellow-orange- | | |
| | | | | purple-blue | | |

The disclosure provides a cooking utensil with a non-stick layer 2. First, a primer layer 21 is attached to a surface of a blank 1 of the cooking utensil, and the primer layer 21 is orderly spread with a sheet-like graphene, a sheet-like graphene derivative or a combination thereof. The orderly arrangement of the sheet-like graphene, the sheet-like graphene derivative or the combination thereof effectively ensure the great performance of the thermal conductivity of the sheet-like graphene, the sheet-like graphene derivative or the combination thereof. Not only the heat conduction is uniform and fast, but also the sheet-like graphene, the sheet-like graphene derivative or the combination thereof in the primer layer 21 have excellent mechanical properties. When the sheet-like graphene, the sheet-like graphene derivative or the combination thereof in the primer layer 21 in cooperation with the uniformly rough structure of the blank 1, an effective support for the entire non-stick layer 2 is performed. The sealing layer 22 forms an effective protection for o the sheet-like graphene, the sheet-like graphene derivative or the combination thereof. Compared with the traditional fluorocarbon coating, the non-stick layer 2 of the present disclosure has the advantages of high surface hardness, good corrosion resistance, long-lasting wear resistance, good non-stickiness and long service life, and is a non-stick layer 2 with environmentally-friendliness, efficiency and comprehensive performance. The disclosure effectively guarantees the firmness and wear resistance of the product, thereby achieving the above-mentioned purpose of the present disclosure.

The above-mentioned embodiments and drawings do not limit the product form and style of the present disclosure, and any appropriate changes or modifications made by those of ordinary skill in the art should be regarded as not departing from the scope of the present disclosure.

What is claimed is:

1. A cooking utensil comprising: a blank of the cooking utensil, and a non-stick layer coated on a surface of the blank; wherein the non-stick layer comprises a primer layer in contact with one side of the blank, and a sheet-like graphene, a sheet-like graphene derivative or a combination thereof uniformly distributed in the primer layer.

2. The cooking utensil as claimed in claim 1, wherein the mass fraction of the sheet-like graphene, the sheet-like graphene derivative or the combination thereof in a water-based paint used to form the primer layer is 28% to 32%.

3. The cooking utensil as claimed in claim 1, wherein a side of the blank facing the non-stick layer has a uniformly rough structure having a roughness ranging from 3 μm to 5 μm.

4. The cooking utensil as claimed in claim 1, wherein a radial width of the sheet-like graphene, the sheet-like graphene derivative or the combination thereof is ranging from 5 μm to 20 μm.

5. The cooking utensil as claimed in claim 1, wherein a thickness of the non-stick layer is ranging from 50 μm to 60 μm.

6. A method for manufacturing of the cooking utensil as claimed in the claim 1, comprising steps of:
S10: roughening the surface of the blank of the cooking utensil, then proceeding to step S20;
S20: spraying a water-based paint containing the sheet-like graphene, the sheet-like graphene derivative or the combination thereof that forms the primer layer on the surface of the blank, then spraying a sealing layer on the undried surface of the primer layer, and baking, and then proceeding to step S30; and
S30: spraying a medium oil layer and a surface oil layer on a surface of the sealing layer in sequence, and then performing firing to obtain a cooking utensil with the non-stick layer.

7. The method for manufacturing of a cooking utensil as claimed in claim 6, wherein the step S10 further comprises a cleaning step and a drying step that after finishing the step of roughening the surface of the blank of the cooking utensil, firstly performing alkaline cleaning at 35° C. to 45° C., then carry out two rounds of washing with water at room temperature, then carrying out acid cleaning at room temperature, then carrying out washing with water at room temperature, and then carrying out washing with pure water at room temperature, and finally drying at 150° C.

8. The method for manufacturing of a cooking utensil as claimed in claim 6, wherein the baking described in the step S20 is baking at a temperature ranging from 150° C. to 180° C. for 3 minutes to 5 minutes.

9. The method for manufacturing of a cooking utensil as claimed in claim 6, wherein the firing described in the step S30 is firing at a temperature of 430° C. for 3 minutes to 5 minutes.

10. The method for manufacturing of a cooking utensil as claimed in claim 6, wherein the step S10 is roughening the surface of the blank of the cooking utensil by sandblasting, and the surface roughness of the blank is 3 μm to 5 μm.

11. The method for manufacturing of a cooking utensil as claimed in claim 6, wherein the sealing layer is formed by 10% polyethersulfone resin and 5% polyamide-imide resin, which are closely combined with polytetrafluoroethylene resin at 150° C. to 180° C., and the mass fraction is 20% to 22%.

12. The method for manufacturing of a cooking utensil as claimed in claim 6, wherein the medium oil layer is formed by filling a material containing 3% to 5% of silicon carbide uniformly into 30% to 55% of fluoropolymer resin at a temperature of 430° C.

13. The method for manufacturing of a cooking utensil as claimed in claim 6, wherein the surface oil layer is using 30% to 55% of fluoropolymer resin co-formed with a polytetrafluoroethylene derived copolymer at a temperature of 430° C., and the mass fraction is 20%.
